(19) United States
(12) Patent Application Publication
(10) Pub. No.: US 2014/0156974 A1
(43) Pub. Date: Jun. 5, 2014

(54) DEVICE OPERATING INFORMATION PROVIDING DEVICE AND DEVICE OPERATING INFORMATION PROVIDING METHOD

(71) Applicant: Azbil Corporation, Tokyo (JP)

(72) Inventor: Toshiya MORITA, Tokyo (JP)

(73) Assignee: Azbil Corporation, Tokyo (JP)

(21) Appl. No.: 14/096,271

(22) Filed: Dec. 4, 2013

(30) Foreign Application Priority Data
Dec. 4, 2012 (JP) 2012-265634

(51) Int. Cl. G06F 9/30

(52) U.S. Cl. CPC G06F 9/30043
USPC 712/225

(57) ABSTRACT

A device operating information providing device includes a control information storing portion that produces and stores, each time an instruction value evaluating portion evaluates that an instruction control value has changed to a different value, control information including the instruction control value after the change, a most recent execution control value acquired by an execution value acquiring portion at the time of the change, and the timing of the change, an operating status evaluating portion that evaluates a device operating status using a change status of the instruction control value and a change status of the execution control value within a specific time interval, which can be specified by control information stored by the control information storing portion, and an operating information transmitting portion that produces, and transmits to a higher-level device side, operating information for the device, using the operating status evaluated by the operating status evaluating portion.

### CROSS REFERENCE TO RELATED APPLICATION

This application claims priority under 35 U.S.C. §119 to Japanese Patent Application No. 2012-265634, filed on Dec. 4, 2012, the entire content of which being hereby incorporated herein by reference.

### FIELD OF TECHNOLOGY

The present invention relates to a device operating information providing device and a device operating information providing method.

### BACKGROUND

In a work area wherein a production process is controlled, various types of devices having communication functions (for example, sensors, valves, and the like) are disposed within a plant, and the signals that are transmitted from the devices are read into a system, to control the various types of production processes. In such a system, a production process is controlled by controlling, for example, the degree of opening of a valve based on the flow rate, temperature, pressure, and the like, acquired from sensors. For example, in Japanese Unexamined Patent Application Publication No. 2012-123446 (“the JP '446”), a technology wherein, in addition to information such as measurement values, control values, and the like, that are displayed for a local device (a field device) on a displaying portion of that device, display information for other devices is displayed as well.

The provision, within a plant, of the device set forth in the JP '446 makes it possible for an operator in the workplace to confirm easily, at that location, the measurement values, control values, and the like, of a device. However, as to whether or not the individual devices are operating properly, merely checking the measurement values, control values, and the like for a device is inadequate, but rather it is necessary also to confirm, for each device, that the device is operating properly according to the control instructions of the controller that controls the device. That is, it is not possible to ascertain accurately whether or not a device is operating properly by monitoring only the measurement values and control values, and the like, of the device. This is a serious problem, particularly for administrators who control multiple devices together.

The present invention was created in order to solve the problem in the conventional technology as set forth above, and an aspect thereof is to provide a device operating information providing device and device operating information providing method that are able to provide information that enables an accurate evaluation of the operating status of a device.

### SUMMARY

A device operating information providing device according to the present invention includes an instruction value acquiring portion that acquires an instruction control value that is a control value that is outputted to a device that receives and sends signals pertaining to a process, an execution value acquiring portion that acquires an execution control value that indicates a value after the control performed by the device on that which is controlled, in accordance with the instruction control value, an instruction value evaluating portion that evaluates whether or not the instruction control value acquired by the instruction value acquiring portion has changed to a different value, a control information storing portion that produces and stores, each time there is an evaluation by the instruction value evaluating portion that the instruction control value has changed to a different value, control information that includes the instruction control value after the change, the most recent execution control value acquired by the execution value acquiring portion at the time of the change, and the timing of the change, an operating status evaluating portion that evaluates a device operating status using a change status of the instruction control value and a change status of the execution control value within a specific time interval, which can be specified by control information that is stored by the control information storing portion, and an operating information transmitting portion that produces, and transmits to a higher-level device side, operating information for the device, using the operating status evaluated by the operating status evaluating portion.

A device operating information providing method according to the present invention includes an instruction value acquiring step for acquiring an instruction control value that is a control value that is outputted to a device that receives and sends signals pertaining to a process, an execution value acquiring step for acquiring an execution control value that indicates a value after the control performed by the device on that which is controlled, in accordance with the instruction control value, an instruction value evaluating step for evaluating whether or not the instruction control value acquired in the instruction value acquiring step has changed to a different value; a control information storing step for producing and storing into a storing device, each time there is an evaluation in the instruction value evaluating step that the instruction control value has changed to a different value, control information that includes the instruction control value after the change, the most recent execution control value acquired in the execution value acquiring step at the time of the change, and the timing of the change, an operating status evaluating step for evaluating a device operating status using a change status of the instruction control value and a change status of the execution control value within a specific time interval, which can be specified by control information that is stored in the control information storing step; and an operating information transmitting step for producing, and transmitting to a higher-level device side, operating information for the device, using the operating status evaluated in the operating status evaluating step.

The use of such a configuration makes it possible to acquire instruction control values that are outputted to the device and execution control values after control that is performed on the controlled device in accordance with those instruction control values, and, each time an instruction control value that is acquired changes to a different value, to store control information that includes the most recent execution control value at the time of the change and the time at which the change occurred, thus making it possible to evaluate the operating status of the device using the status of change of the instruction control values and the status of change of the execution control values within a specific time interval, which can be specified by the control information, enabling device operating information, including the operating status that has been determined, to be sent to the higher-level device side. This makes it possible to provide, to the administrator, operating information that includes the operating status of the device, determined by taking into consideration the instruction control values that were sent to the device, rather than just the execution control values that have been executed by the device.

The device operating information providing portion may be such that the operating status evaluating portion evaluates that there is a device failure if, within a first time interval that is set in advance, the instruction control value changes by at least a first threshold value and the change in the execution control value is less than a second threshold value, despite a second time interval that is set in advance having elapsed.

A measurement value acquiring portion for acquiring a measurement value, performed on that which is to be measured, by another device that is disposed in the vicinity of the device may further be provided. The operating information transmitting portion adds, to the operating information, the measurement value acquired by the measurement value acquiring portion.

Through this, the administrator who analyzes the operating information is able to improve the evaluation accuracy due to the ability to take into consideration secondary information such as the pressures, flow rates, temperatures, and the like, around the device when evaluating the operating status of the device.

The present invention enables the provision of a device operating information providing device and device operating information providing method that are able to provide information by which the operating status of a device can be evaluated accurately.

### BRIEF DESCRIPTIONS OF THE DRAWINGS

FIG. 1 is a block diagram illustrating an example configuration for a process controlling system that includes a device operating information providing device according to an example.

FIG. 2 is a block diagram illustrating a functional structure for the HART communicating device and analog I/O device illustrated in FIG. 1.

FIG. 3 is a sequence diagram for explaining the operating procedure when providing, to an instrument monitoring device, operating information for a HART communication-compatible instrument in the process controlling system illustrated in FIG. 1.

### DETAILED DESCRIPTION

An example according to the present invention will be explained below in reference to the drawings. However, the example explained below is no more than an illustration, and does not exclude various modifications and applications to technologies not explicated below. That is, the present invention can be embodied in a variety of modified forms, in the scope that does not deviate from the spirit and intent thereof.

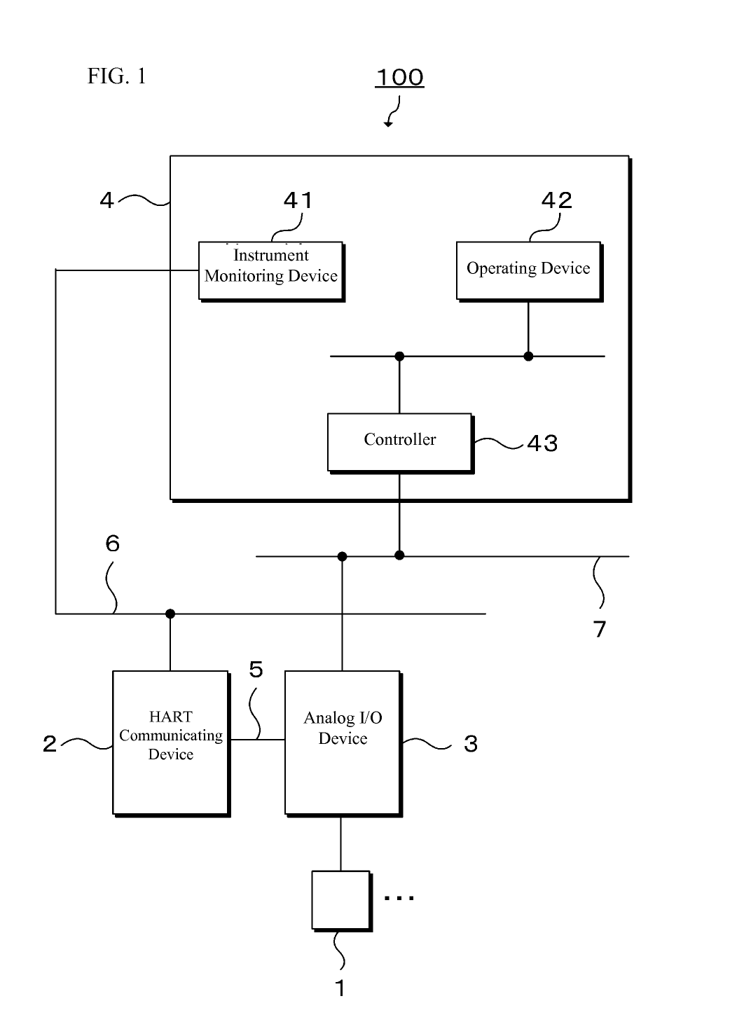

The structure of the process controlling system that includes the device operating information providing device according to the example will be explained first in reference to FIG. 1. As illustrated in FIG. 1, a process controlling system 100 comprises: a HART (Highway Addressable Remote Transducer) communication-compatible instrument 1 that is, for example, a device; a HART communicating device 2 that is an interface device that has a HART communication function; an analog I/O device 3 that is an input/output device for inputting and outputting analog signals to and from the HART communication-compatible instrument 1; and a higher-level system 4.

The higher-level system 4 includes an instrument monitoring device 41, an operating device 42, and a controller 43. In the higher-level system 4, the instrument monitoring device 41 functions as a monitoring system for monitoring the status, etc., of the HART communication-compatible instrument 1, and the operating device 42 and the controller 43 function as the controlling system for controlling the production process.

The instrument monitoring device 41 and the HART communicating device 2 are connected by a communication cable 6 such as of the Ethernet™ standard, and the controller 43 and the analog I/O device 3 are connected through, for example, a communication bus 7. Moreover, the analog I/O device 3 and the HART communicating device 2 are connected through a communication bus 5 of, for example, the Modbus™ standard.

In the present example, the HART communicating device 2, illustrated in FIG. 1, will be explained for a case wherein it functions as a device operating information providing device according to the present invention. Note that devices that function as device operating information providing devices are not limited to being a HART communicating device 2. For example, a HART-I/O device wherein the HART communicating device 2 that is illustrated in FIG. 1 is combined with an analog I/O device 3 may instead function as the device operating information providing device.

HART communication-compatible instruments 1 are various types of devices provided within the plant. As HART communication-compatible instruments 1 there are, for example, transmitting devices for transmitting pressures, flow rates, temperatures, and the like, positioners for changing or detecting the amount of opening of valves such as pressure regulating valves or flow rate regulating valves, actuators that operate, for example, pumps and fans, and the like. A HART communication-compatible instrument 1 is provided with a HART communication function, to input and output HART communication signals.

Here the HART communication is communication that uses a protocol for transmitting HART communication signals. A HART communication signal is a signal that is produced by superimposing an AC signal onto a DC signal of between 4 and 20 mA. The AC signal is produced by assigning the logic of a digital signal to an analog signal of either 2200 Hz or 1200 Hz, and then converting thereto.

The DC signal of between 4 and 20 mA that is included in the HART communication signal is a signal that indicates a single variable value that is set for each HART communication-compatible instrument 1. The variable value is data pertaining to the process, such as, for example, a measurement value such as a pressure, a flow rate, a temperature, or the like, or a control value such as a degree of opening. The digital signal that corresponds to the AC signal that is included in the HART communication signal is a signal that corresponds to various types of data that can, for example, be collected within the HART communication-compatible instrument 1. As these types of data there are, for example, process information in the HART communication-compatible instrument 1, or diagnostic information for the hardware that is incorporated into the HART communication-compatible instrument 1. Note that measurement values and control values of the HART communication-compatible instrument may also be included in the various types of data.

The analog I/O device 3 has a plurality of ports, and a HART communication-compatible instrument 1 is connected to an individual port. The analog I/O device 3 intermediates the DC signals of between 4 and 20 mA that are exchanged between the controller 43 and the HART communication-compatible instrument 1. The analog I/O device 3 intermediates the HART communication signals that are exchanged between the HART communicating device 2 and the individual HART communication-compatible instruments 1.

Note that while in the present example the analog I/O device 3 intermediates the 4 through 20 mA DC signals, there is no limitation thereto. For example, if the configuration is one wherein the HART communication-compatible instrument 1, the HART communicating device 2, and the analog I/O device 3 are connected together, then the 4 to 20 mA DC signal may be exchanged directly between the controller 43 and the individual HART communication-compatible instruments 1, or the exchange may be intermediated by either the HART communicating device 2 or the analog I/O device 3.

When a HART communicating device 2 has received a digital signal that is sent from the instrument monitoring device 41 to an individual HART communicating device 2, the HART communication signal is produced by superimposing, onto the 4 through 20 mA DC signal that is sent from the controller 43 to the individual HART communication-compatible instrument 1, an AC signal that corresponds to the digital signal that has been received from the instrument monitoring device 41. When a HART communication signal has been received by an individual HART communicating device 2, the HART communicating device 2 separates it into a DC signal of between 4 and 20 mA and a digital signal that corresponds to the AC signal, and transmits the separated digital signal to the instrument monitoring device 41.

The instrument monitoring device 41 periodically sends a request signal to each HART communication-compatible instrument 1 through the HART communicating device 2, and receives response signals in response to the request signals. Based on the response signals received, the instrument monitoring device 41 evaluates the state of execution of the processes of the HART communication-compatible instruments 1, failure states of hardware incorporated into the HART communication-compatible instruments 1, required timing for maintenance and repairs of the HART communication-compatible instruments 1, and so forth. The instrument monitoring device 41 displays the evaluation results on a monitor (not shown). Doing so enables the administrator to ascertain the status of the HART communication-compatible instruments 1.

The controller 43 controls the HART communication-compatible instrument 1 analog I/O device 3 to control the status of execution of the manufacturing process. For example, the controller 43 regulates the opening of a valve through outputting a control value, such as the degree of valve opening, to a HART communication-compatible instrument 1 based on a measurement value, such as a pressure or a flow rate, acquired from another HART communication-compatible instrument 1.

The operating device 42 displays the operating detail of the HART communication-compatible instrument 1 on a monitor not shown), based on the 4 to 20 mA DC signals received from the controller 43. Doing so enables the operator to ascertain the input/output status of the HART communication-compatible instruments 1. The operating device 42 operates the operating state of the controller 43 in accordance with operating instructions from the operator. The operating detail of the operating status may be, for example, an operation for starting-up or an operation for shutting-down a controller 43.

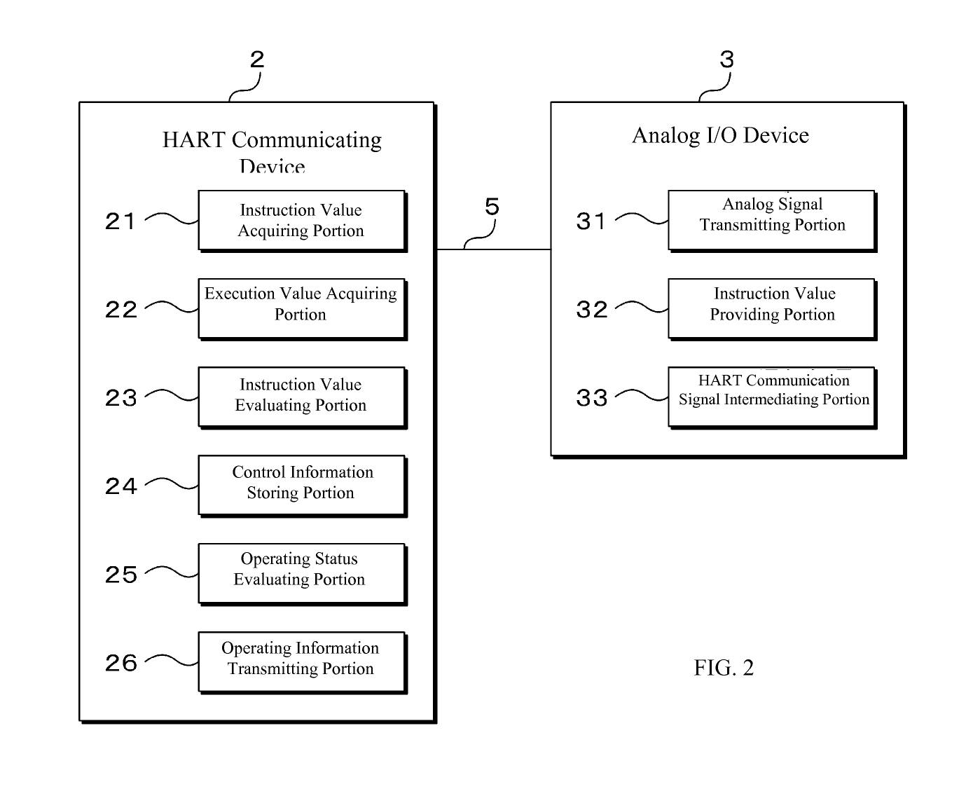

The functional structure of a HART communicating device 2 and of an analog I/O device 3 will be explained in reference to FIG. 2. As illustrated in FIG. 2, the HART communicating device 2 has, for example, an instruction value acquiring portion 21, an execution value acquiring portion 22, an instruction value evaluating portion 23, a control information storing portion 24, an operating status evaluating portion 25, and an operating information transmitting portion 26.

The instruction value acquiring portion 21 acquires, from the analog I/O device 3, an instruction control value that is a control value that has been outputted to the HART communication-compatible instrument 1 through the analog I/O device 3 from the controller 43. As an example, if the HART communication-compatible instrument 1 is a valve positioner, the instruction control value is the degree of opening of the valve, such as a pressure regulating valve or a flow rate regulating valves. Specifically, “50%” or “55%,” which indicate the degree of opening of a valve, would be the instruction control value.

The instruction value acquiring portion 21 periodically (for example, once per second) sends a request signal to the analog I/O device 3 to acquire the instruction control value from the analog I/O device 3.

The execution value acquiring portion 22 acquires, from the HART communication-compatible instrument 1, an execution control value that indicates the value after control that is performed on the controlled device by the HART communication-compatible instrument 1 in accordance with the instruction control value. As an illustration, if the HART communication-compatible instrument 1 is a valve positioner, then the execution control value would be the degree of opening of the valve, such as a flow rate regulating valve or a pressure regulating valve, the same as for the instruction control value, described above.

The execution value acquiring portion 22 periodically (for example, once per second) sends a request signal to the HART communication-compatible instrument 1 through the analog I/O device 3 to acquire the execution control value from the HART communication-compatible instrument 1.

The instruction value evaluating portion 23 evaluates whether or not the instruction control value acquired by the instruction value acquiring portion 21 has changed to a different value.

Each time there is an evaluation by the instruction value evaluating portion 23 that the instruction control value has changed to a different value, the control information storing portion 24 produces control information corresponding to that HART communication-compatible instrument 1 and stores, into the memory, the control information that has been produced. The control information includes, for example, a device ID that specifies the HART communication-compatible instrument 1, the new execution control value that is acquired by the execution value acquiring portion 22 at the time at which the instruction control value has changed, and the timing with which the instruction control value was changed.

The operating status evaluating portion 25 evaluates the operating status of the HART communication-compatible instrument 1 by referencing the control information that has been stored in memory by the control information storing portion 24. Specifically, the operating status evaluating portion 25 uses an evaluation criterion that has been established in advance to evaluate whether or not the HART communication-compatible instrument 1 is operating properly. The evaluation criterion may be set using, for example, a state of change of the instruction control value and a state of change of the execution control value within a specific time interval.

As an example, if the HART communication-compatible instrument 1 is a valve positioner, then evaluation criteria may be set as follows. If the instruction control value has changed by at least “5%” upward within “10 seconds,” and the execution control value has changed by at least “4%” within “15 seconds” from the time at which the change started, then the valve positioner is evaluated as operating properly. Note that in regards to the aforementioned “5%,” “10 seconds,” “4%,” and “15 seconds,” the details of the settings may be modified as appropriate depending on the device performance, the setting environment, and the like.

When the evaluation criteria are set in this way, the operating status evaluating portion 25 evaluates the operating status of the valve positioner as follows. For example, if the instruction control value has changed from “50%” to “55%” within “10 seconds,” and the execution control value has from “50%” to at least “54%” within “15 seconds,” then the valve positioner is evaluated as operating properly.

On the other hand, if despite the instruction control value changing from “50%” to “55%” within “10 seconds” and more than “15 seconds” have elapsed from the time at which the change from “50%” started, the execution control value is still less than “54%,” then the valve positioner is evaluated as having a fault.

The operating information transmitting portion 26 produces operating information for a HART communication-compatible instrument 1, and sends, to the instrument monitoring device 41, the operating information that has been produced. The operating information includes, for example, a device ID that specifies the HART communication-compatible instrument 1, and the operating status of the HART communication-compatible instrument 1 that has been evaluated by the operating status evaluating portion 25.

The analog I/O device 3 that is illustrated in FIG. 2 has, for example, an analog signal transmitting portion 31, an instruction value providing portion 32, and a HART communication signal intermediating portion 33.

The analog signal transmitting portion 31 transmits, to a HART communication-compatible instrument 1 corresponding to the destination, a DC signal of between 4 and 20 mA that is outputted to an individual HART communication-compatible instrument 1 from the controller 43. The analog signal transmitting portion 31 transmits, to the controller 43, a DC signal of between 4 and 20 mA that is outputted from an individual HART communication-compatible instrument 1 to the controller 43.

When a HART communicating device 2 has received a request signal that is outputted to a specific HART communication-compatible instrument 1 requesting an instruction control value, the instruction value providing portion 32 sends, as a response signal to the HART communicating device 2, the instruction control signal that is outputted by the specific HART communication-compatible instrument 1 at that point in time.

The HART communication signal intermediating portion 33 intermediates the HART communication signals that are exchanged between the HART communicating device 2 and the individual HART communication-compatible instrument 1.

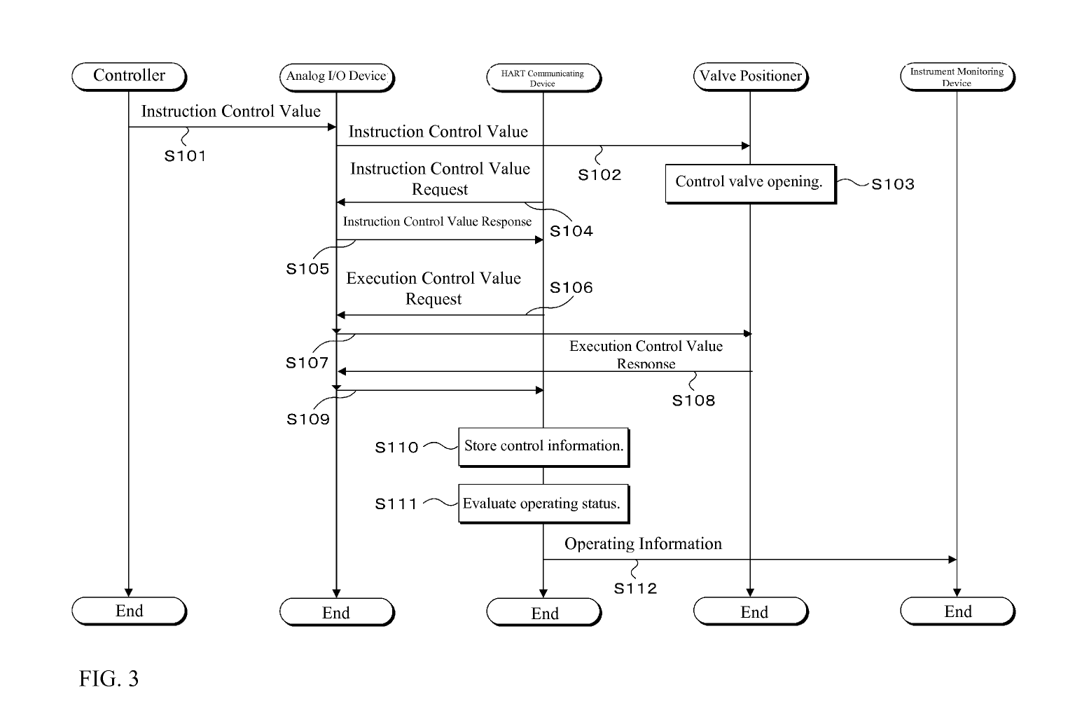

The operating procedure in the process controlling system in the present example when operating information for a HART communication-compatible instrument is provided to the instrument monitoring device will be explained in reference to FIG. 3. For convenience in the explanation, in this operating procedure the explanation will be for a case wherein the HART communication-compatible instrument 1 is a valve positioner.

First, the controller 43 outputs an instruction control value through a DC signal of between 4 and 20 mA, for indicating the degree of opening of a valve to a valve positioner, through the analog I/O device 3 (Step S101) to the valve positioner (Step S102). The valve positioner controls the opening of the valve in accordance with the instruction control value (Step S103).

The instruction value acquiring portion 21 of the HART communicating device 2 sends a request signal, for requesting the instruction control value from the valve positioner, to the analog I/O device 3 periodically (Step S104), and receives a response signal from the analog I/O device 3, to acquire the instruction control value of the valve positioner (Step S105).

The execution value acquiring portion 22 of the HART communicating device 2 sends a request signal, for requesting the execution control value of the positioner periodically through the analog I/O device 3 (Step S106) to the valve positioner (Step S107), and receives the response signal from the valve positioner through the analog I/O device 3 (Step S108), to acquire the execution control value of the positioner (Step S109).

Following this, the instruction value evaluating portion 23 of the HART communicating device 2 evaluates whether or not the instruction control value acquired in Step S105, above, has changed to a different value, and each time the instruction control value changes to a different value, the control information storing portion 24 of the HART communicating device 2 produces control information that includes the instruction control value after the change, the execution control value that is acquired at that point in time, and the timing at that point in time, and stores into memory the control information that is produced (Step S110).

Following this, the operating status evaluating portion 25 of the HART communicating device 2 references the control information that is stored in memory and uses an evaluation criterion that has been established in advance to evaluate the operating status of the valve positioner (Step S111).

Following this, the operating information transmitting portion 26 of the HART communicating device 2 produces operating information for the valve positioner using the operating status that was evaluated in Step S111, above, and sends, to the instrument monitoring device 41, the operating information that has been produced (Step S112).

As described above, the process controlling system 100 according to the present example acquires the instruction control value that is outputted to the valve positioner, and the execution control value after the valve positioner has controlled that which is controlled in accordance with the instruction control value, and each time the instruction control value that is acquired changes to a different value, control information that includes the instruction control value after the change, the most recent execution control value at the time of the change, and the timing of the change is stored, and the state of change of the instruction control value and the state of change of the execution control value, within a specific time interval, which can be specified from the control information, are used to evaluate the operating status of the valve positioner, making it possible to send, to the instrument monitoring device, operating information for the valve positioner, including the operating status that has been evaluated.

As a result, it is possible to provide, to the administrator, operating information that includes the operating status of the valve positioner, evaluated taking into account not only the execution control value that has been executed by the valve positioner, but also the instruction control value that was indicated to the valve positioner.

### Modified Example

Note that while in the example set forth above the operating information transmitting portion 26 produced operating information of the valve positioner, which is sent to the instrument monitoring device 41, using the operating status of the valve positioner as evaluated by the operating status evaluating portion 25, measurement values, and the like, for other HART communication-compatible instruments 1 may also be added to the operating information. For example, the individual measurement values of a pressure sensor, a flow rate sensor, and a temperature sensor that are installed in the vicinity of the valve positioner may be added to the operating information for the valve positioner. Doing so enables the administrator who analyzes the operating information to improve the evaluation accuracy through taking into account secondary information, such as the pressures, flow rates temperatures, and the like, in the vicinity of the valve positioner when evaluating the operating status of the valve positioner.

In the present modified example, the HART communicating device 2 may have a measurement value acquiring portion in addition to the various portions illustrated in FIG. 2. The measurement value acquiring portion acquires, from the HART communication-compatible instrument 1, measurement values measured by the HART communication-compatible instrument 1. As an example, if the HART communication-compatible instrument 1 is a pressure sensor, then the measurement value would be the pressure that is subject to measurement.

The operating information transmitting portion in the present modified example produces operating information wherein the measurement values acquired by the measurement value acquiring portion are added to the operating information of the example set forth above, and sends, to the instrument monitoring device 41, the operating information that has been produced.

1. A device operating information providing device comprising:
an instruction value acquiring portion that acquires an instruction control value that is a control value that is outputted to a device that receives and sends signals pertaining to a process;
an execution value acquiring portion that acquires an execution control value that indicates a value after the control performed by the device on that which is controlled, in accordance with the instruction control value;
an instruction value evaluating portion that evaluates whether or not the instruction control value acquired by the instruction value acquiring portion has changed to a different value;
a control information storing portion that produces and stores, each time there is an evaluation by the instruction value evaluating portion that the instruction control value has changed to a different value, control information that includes the instruction control value after the change, the most recent execution control value acquired by the execution value acquiring portion at the time of the change, and the timing of the change;
an operating status evaluating portion that evaluates a device operating status using a change status of the instruction control value and a change status of the execution control value within a specific time interval, which can be specified by control information that is stored by the control information storing portion; and
an operating information transmitting portion that produces, and transmits to a higher-level device side, operating information for the device, using the operating status evaluated by the operating status evaluating portion.

2. The device operating information providing portion as set forth in claim 1, wherein:
the operating status evaluating portion evaluates that there is a device failure if, within a first time interval that is set in advance, the instruction control value changes by at least a first threshold value and the change in the execution control value is less than a second threshold value, despite a second time interval that is set in advance having elapsed.

3. The device operating information providing device as set forth in claim 1, further comprising:
a measurement value acquiring portion that acquires a measurement value, performed on that which is to be measured, by another device that is disposed in the vicinity of the device, wherein:
the operating information transmitting portion adds, to the operating information, the measurement value acquired by the measurement value acquiring portion.

4. The device operating information providing method including:
an instruction value acquiring step for acquiring an instruction control value that is a control value that is outputted to a device that receives and sends signals pertaining to a process;
an execution value acquiring step for acquiring an execution control value that indicates a value after the control performed by the device on that which is controlled, in accordance with the instruction control value;
an instruction value evaluating step for evaluating whether or not the instruction control value acquired in the instruction value acquiring step has changed to a different value;
a control information storing step for producing and storing into a storing device, each time there is an evaluation in the instruction value evaluating step that the instruction control value has changed to a different value, control information that includes the instruction control value after the change, the most recent execution control value acquired in the execution value acquiring step at the time of the change, and the timing of the change;
an operating status evaluating step for evaluating a device operating status using a change status of the instruction control value and a change status of the execution control value within a specific time interval, which can be specified by control information that is stored in the control information storing step; and
an operating information transmitting step for producing, and transmitting to a higher-level device side, operating information for the device, using the operating status evaluated in the operating status evaluating step.
